(19) United States
(12) Patent Application Publication
(10) Pub. No.: US 2023/0371566 A1
(43) Pub. Date: Nov. 23, 2023

(54) BOBA WITH IMPROVED FLAVOR AND COLOR FEATURES AND METHODS OF MAKING AND USING SAME

(71) Applicant: Starbucks Corporation, Seattle, WA (US)

(72) Inventor: Jennica Mjelde, Maple Valley, WA (US)

(21) Appl. No.: 18/200,097

(22) Filed: May 22, 2023

Related U.S. Application Data
(60) Provisional application No. 63/344,198, filed on May 20, 2022.

(51) Int. Cl. A23L 27/00; A23L 29/30; A23L 29/256; A23L 29/00; A23C 11/10; A23F 5/24; A23F 3/16; A23L 19/00; A23L 2/385; A23L 2/58; A23L 2/60; A23P 20/17

(52) U.S. Cl. CPC A23L 27/72; A23L 29/30; A23L 29/256; A23L 29/015; A23C 11/103; A23C 11/10; A23F 5/243; A23F 3/163; A23L 19/05; A23L 2/385; A23L 2/58; A23L 2/60; A23P 20/17

(57) ABSTRACT

The disclosure relates to comestible capsules, methods of making the comestible capsules, and methods of using the comestible capsules food products (e.g., beverages) such as, for example, coffees, teas, refreshers, and waters. This abstract is intended as a scanning tool for purposes of searching in the particular art and is not intended to be limiting of the present invention.

### CROSS-REFERENCE TO RELATED APPLICATIONS

This application claims the benefit of U.S. Provisional Application No. 63/344,198, filed on May 20, 2022, the contents of which are incorporated herein by reference in their entirety.

### BACKGROUND

Bubble tea (also known as pearl milk tea, bubble milk tea, tapioca milk tea, or boba tea) is a tea-based beverage that contains translucent spheres produced from tapioca, a starch extracted from the cassava root. These tapioca balls or boba come in a variety of different forms including original black, flavored, mini, and clear. Typically, the boba lack flavor and are added merely to provide texture. More recently, however, popping boba has been produced, in which the boba contain a fruit juice within the sphere. In this way, both flavor and texture are added.

The popularity of bubble tea has steadily grown over the years. A 2020 market research report from Fortune Business Insights estimates the global market for bubble tea at just about $2 billion in 2019. Growth is projected to hit about $3.4 billion by 2027.

Despite these successes, the versatility of boba continues to be restricted by the limited flavors and colors that are tolerated. Thus, there remains a need for boba that contain a flavored base component other than fruit juice, as well as boba that have unique colors (e.g., marbleized boba) and/or textures. These needs and others are met by the present invention.

### SUMMARY

In accordance with the purpose(s) of the invention, as embodied and broadly described herein, the invention, in one aspect, relates to comestible capsules having a flavored base component (e.g., an alternative dairy product, a syrup, a sauce, a refresher, a coffee, a tea) and an encapsulation surface, methods of making the comestible capsules, and methods of using the comestible capsules in food products (e.g., beverages) such as, for example, coffees, teas, refreshers, and waters. In various aspects, the disclosed comestible capsule can be marbleized by, for example, combining a colored, flavored base component and a colorant or by combining two different colorants.

Thus, disclosed are comestible capsules, comprising: (a) a core composition comprising at least one flavored base component selected from an alternative dairy product, a syrup, a sauce, a coffee, and a tea; and (b) an encapsulation surface comprising a gelled polysaccharide, which encapsulates the core composition.

Also disclosed are comestible capsules, comprising: (a) a core composition comprising at least one flavored base component and at least two colorants, wherein each colorant has a different color; and (b) an encapsulation surface comprising a gelled polysaccharide, which encapsulates the core composition, wherein the capsule has a marbleized color.

Also disclosed are compositions comprising a plurality of the disclosed comestible capsules, wherein the composition is a food product.

Also disclosed are methods of making a disclosed comestible capsule, the method comprising: (a) providing the core composition; and (b) dispensing the core composition dropwise into a bath comprising an encapsulating agent, thereby forming an encapsulation surface, provided that: if the core composition comprises a polysaccharide, then the encapsulating agent is a calcium ion source, and if the core composition comprises a calcium ion source, then the encapsulating agent is a polysaccharide.

Also disclosed are methods of making a disclosed comestible capsule, the method comprising: (a) providing the core composition; (b) sequentially adding a first colorant and a second colorant dropwise into the core composition, wherein the second colorant has a different color than the first colorant, thereby forming a marbleized core composition; and (c) dispensing the marbleized core composition dropwise into a bath, thereby forming the encapsulation surface, provided that: if the core composition comprises a polysaccharide, then the encapsulating agent is a calcium ion source, and if the core composition comprises a calcium ion source, then the encapsulating agent is a polysaccharide.

Also disclosed are comestible capsules prepared by a disclosed method.

Additional advantages of the invention will be set forth in part in the description which follows, and in part will be obvious from the description, or can be learned by practice of the invention. The advantages of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE FIGURES

The accompanying figures, which are incorporated in and constitute a part of this specification, illustrate several aspects and together with the description serve to explain the principles of the invention.

FIG. 1A-C show representative images of exemplary comestible capsules prepared using a variety of different flavored base components, including (left to right) strawberry acai, kiwi, cherry, blueberry, almond milk, soy milk, coconut milk, mocha sauce (FIG. 1A), black tea, apple juice, oatmilk, passion tea, vanilla syrup, mango dragonfruit, green tea, mango dragonfruit (red colored), mango dragonfruit (yellow colored), mango dragonfruit (blue colored) (FIG. 1B), chai, chai, and chai (all different variations on chai as the base) (FIG. 1C).

FIG. 2 shows a representative image of a black cold brew coffee containing a plurality of comestible capsules prepared using an alternative dairy product.

FIG. 3A-C show representative images of exemplary comestible capsules marbleized using blue (FIG. 3A and FIG. 3C, right) and green (FIG. 3B and FIG. 3C, left) on a white base.

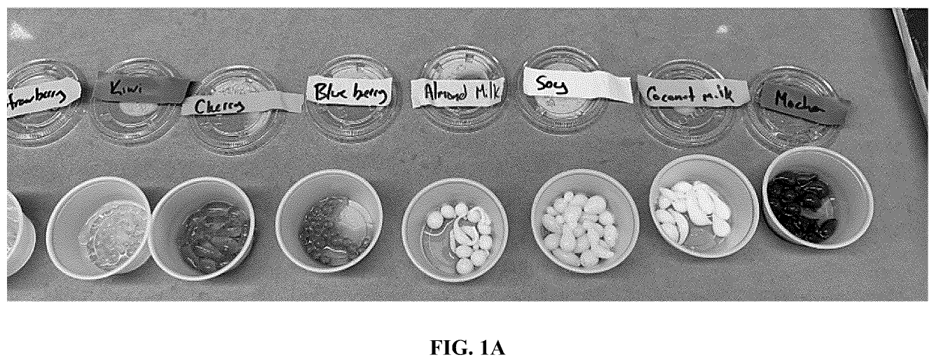

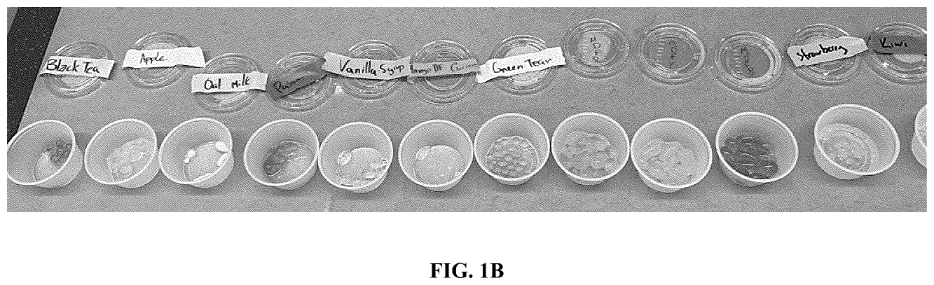

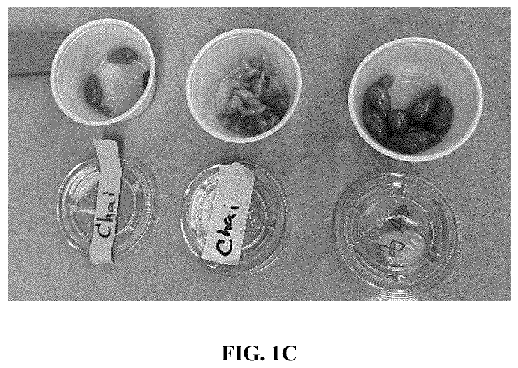

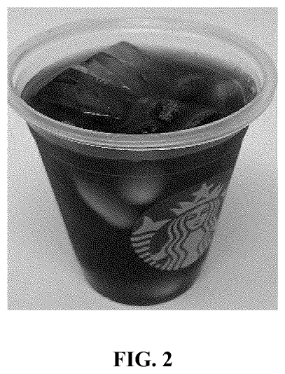

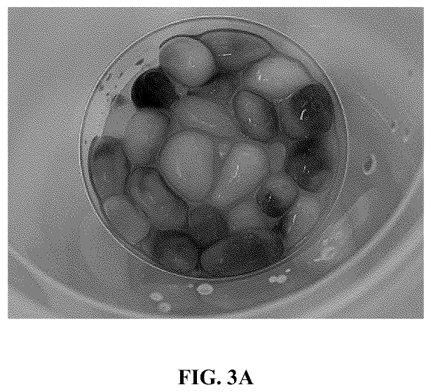

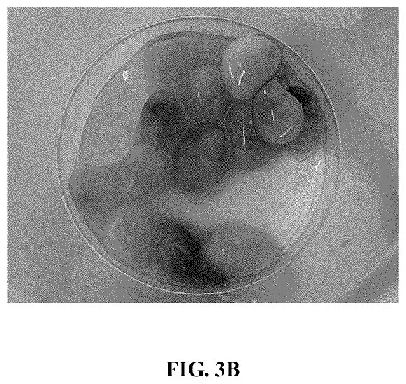

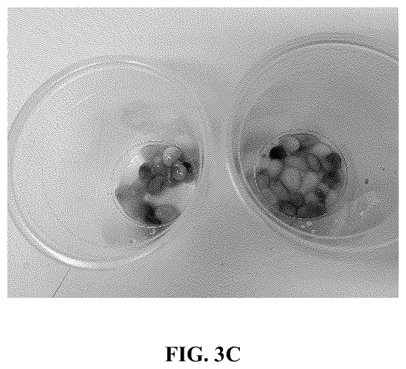

Additional advantages of the invention will be set forth in part in the description which follows, and in part will be obvious from the description, or can be learned by practice of the invention. The advantages of the invention will be realized and attained by means of the elements and combinations particularly pointed out in the appended claims. It is to be understood that both the foregoing general description and the following detailed description are exemplary and explanatory only and are not restrictive of the invention, as claimed.

### DETAILED DESCRIPTION

The present invention can be understood more readily by reference to the following detailed description of the invention and the Examples included therein.

Before the present capsules, compositions, and/or methods are disclosed and described, it is to be understood that they are not limited to specific methods unless otherwise specified, or to particular reagents unless otherwise specified, as such may, of course, vary. It is also to be understood that the terminology used herein is for the purpose of describing particular aspects only and is not intended to be limiting. Although any methods and materials similar or equivalent to those described herein can be used in the practice or testing of the present invention, example methods and materials are now described.

Disclosed are the components to be used to prepare the capsules and compositions of the invention as well as the capsules and compositions themselves to be used within the methods disclosed herein. These and other materials are disclosed herein, and it is understood that when combinations, subsets, interactions, groups, etc. of these materials are disclosed that while specific reference of each various individual and collective combinations and permutation of these capsules cannot be explicitly disclosed, each is specifically contemplated and described herein. For example, if a particular capsule is disclosed and discussed and a number of modifications that can be made to a number of materials including the capsules are discussed, specifically contemplated is each and every combination and permutation of the capsule and the modifications that are possible unless specifically indicated to the contrary. Thus, if a class of materials A, B, and C are disclosed as well as a class of materials D, E, and F and an example of a combination material, A-D is disclosed, then even if each is not individually recited each is individually and collectively contemplated meaning combinations, A-E, A-F, B-D, B-E, B-F, C-D, C-E, and C-F are considered disclosed. Likewise, any subset or combination of these is also disclosed. Thus, for example, the sub-group of A-E, B-F, and C-E would be considered disclosed. This concept applies to all aspects of this application including steps in methods of making and using the capsules and compositions of the invention. Thus, if there are a variety of additional steps that can be performed it is understood that each of these additional steps can be performed with any specific embodiment or combination of embodiments of the methods of the invention.

While aspects of the present invention can be described and claimed in a particular statutory class, such as the system statutory class, this is for convenience only and one of skill in the art will understand that each aspect of the present invention can be described and claimed in any statutory class. Unless otherwise expressly stated, it is in no way intended that any method or aspect set forth herein be construed as requiring that its steps be performed in a specific order. Accordingly, where a method claim does not specifically state in the claims or descriptions that the steps are to be limited to a specific order, it is no way intended that an order be inferred, in any respect. This holds for any possible non-express basis for interpretation, including matters of logic with respect to arrangement of steps or operational flow, plain meaning derived from grammatical organization or punctuation, or the number or type of aspects described in the specification.

Throughout this application, various publications are referenced. The disclosures of these publications in their entireties are hereby incorporated by reference into this application in order to more fully describe the state of the art to which this pertains. The references disclosed are also individually and specifically incorporated by reference herein for the material contained in them that is discussed in the sentence in which the reference is relied upon. Nothing herein is to be construed as an admission that the present invention is not entitled to antedate such publication by virtue of prior invention. Further, the dates of publication provided herein may be different from the actual publication dates, which can require independent confirmation.

### A. Definitions

As used in the specification and the appended claims, the singular forms “a,” “an” and “the” include plural referents unless the context clearly dictates otherwise. Thus, for example, reference to “a comestible capsule,” “a core composition,” or “a syrup” includes mixtures of two or more such comestible capsules, core compositions, or syrups, and the like.

References to a capsule or a composition containing “an” ingredient is intended to include other ingredients, respectively, in addition to the one named.

By “comprising” or “containing” or “having” it is intended that at least the named component, element, material, or method step, etc., is present in the capsule, composition, or method, but does not exclude the presence of other components, elements, materials, method steps, etc., even if the other such components, elements, materials, method steps, etc., have the same function as what is named, unless expressly excluded in the claims.

Ranges can be expressed herein as from “about” one particular value, and/or to “about” another particular value. When such a range is expressed, another aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. It is also understood that each unit between two particular units are also disclosed. For example, if 10 and 15 are disclosed, then 11, 12, 13, and 14 are also disclosed.

As used herein, the terms “optional” or “optionally” means that the subsequently described event or circumstance may or may not occur, and that the description includes instances where said event or circumstance occurs and instances where it does not.

As used herein, the term “comestible capsule” refers to an edible, biodegradable gelatin or gelatin-like structure that is intended to be added to a food product such as a beverage. Similar to a boba pearl, the comestible capsules disclosed herein can have a thin, gel-like skin with a flavored liquid contained therein that bursts when squeezed (e.g., a popping boba pearl) or can have a thicker outer membrane with gel-like consistency throughout (e.g., a solid boba pearl). The comestible capsule is fairly small such that it can readily be incorporated into a meal or a beverage. For example, the comestible capsule can be put into a beverage or on top of a dessert. Thus, in various aspects, the comestible capsule has a maximum length of from about 4 mm to about 8 mm, about 4 mm to about 7 mm, about 4 mm to about 6 mm, about 4 mm to about 5 mm, about 5 mm to about 8 mm, about 6 mm to about 8 mm, about 7 mm to about 8 mm, or about 5 mm to about 7 mm. The comestible capsule a maximum width of from about 4 mm to about 8 mm, about 4 mm to about 7 mm, about 4 mm to about 6 mm, about 4 mm to about 5 mm, about 5 mm to about 8 mm, about 6 mm to about 8 mm, about 7 mm to about 8 mm, or about 5 mm to about 7 mm. The comestible capsule can have a variety of different shapes including, but not limited to, a round shape, an elliptical shape, or a tear-drop shape.

As used herein, the term “core composition” refers to the interior make-up of the comestible capsule. As further described herein, the consistency of the core composition can differ based on the protocol used to prepare the capsule and the materials selected. Thus, in various aspects, the core composition can be a liquid such as, for example, when a spherification process is used to prepare the comestible capsule. In this particular aspect, the core composition can contain, inter alia, at least one flavored base component, a gum, and a calcium ion source. In various further aspects, the core composition can be a gel such as, for example, when a reverse spherification process is used to prepare the comestible capsule. In this particular aspect, the core composition can contain, inter alia, at least one flavored base component and a gelled polysaccharide. Additional embodiments of the core composition are described elsewhere herein.

As used herein, the term “encapsulation surface” refers to the exterior surface of the comestible capsule that entirely or substantially entirely surrounds and contains the core composition. Similar to the core composition, the consistency of the encapsulation surface can differ based on the protocol used to prepare the capsule and the materials selected. Thus, in various aspects, the encapsulation surface can be the exterior surface of a thin, gel-like membrane that contains, inter alia, a gelled alginate and that has a different consistency than the core composition. Such an encapsulation surface can be formed by, for example, using a spherification process. In various further aspects, the encapsulation surface can be the exterior surface of a thicker membrane that contains, inter alia, a gelled alginate and a calcium ion source, wherein the thicker membrane is the same or substantially the same consistency as the core composition. This type of encapsulation surface can be formed by, for example, using a reverse spherification process. Additional embodiments of the encapsulation surface are described elsewhere herein.

As used herein, the term “food product” refers to a good or product that is intended for consumption by, for example, a human. Examples of food products include, but are not limited to, syrups, sauces, extracts, alternative dairy products, beverages (e.g., coffees such as instant coffees, cold brews, hot brews, traditional brews, and blended coffees, teas, fruit juices, smoothies, waters such as still waters and sparkling waters, liquors, liqueurs, mixtures thereof), desserts (e.g., ice creams, flans, cakes, custards, pies, yogurts, shaved ice, tarts), and dough-based food products (e.g., croissants, waffles, pancakes, breads).

As used herein, the term “alternative dairy product” refers to a food product that is not made from and does not contain cow's milk. Rather, an alternative dairy product can be used in place of a product that is made from or otherwise contains cow's milk. Examples of alternative dairy products include, but are not limited to, milks, creamers, and yogurts that are made from soy, oat, rice, almond, coconut, chia, and hemp seed (e.g., vegan milk). Thus, in various aspects, the alternative dairy product is a dairy milk or a dairy creamer. In various further aspects, the dairy milk or the dairy creamer is selected from coconut milk, oat milk, soy milk, almond milk, and chia milk.

As used herein, the term “syrup” refers to a food product that is a thick, viscous liquid consisting primarily of a solution of sugar in water. Exemplary syrups include, but are not limited to, acetomel, agave, attar, barley malt, birch, bludwine, brown rice, chashni, cheong, chocolate, cider, corn, date honey, sugar cane, dried cane, falernum, fruit, flavored, glucose, golden, grape, grenadine, honey, inverted sugar, kuromitsu, maple, mizuame, molasses, orgeat, palm, pekmex, rose, squash, sugar beet, sweet sorghum, treacle, vanilla, and vincotto. In various aspects, the syrup can be flavored. Exemplary syrup flavorings include, but are not limited to, chocolate, vanilla, caramel, raspberry, brown sugar, coffee, cascara, cherry, peach, malt, hazelnut, coconut, almond, gingerbread, pumpkin, spice, peppermint, rootbeer, and marshmallow. In various aspects, the syrup is selected from a chocolate syrup, a vanilla syrup, a caramel syrup, a raspberry syrup, a brown sugar syrup, and a cascara syrup.

As used herein, the term “sauce” refers to a food product that is a thick liquid typically used to add moistness and/or flavor to food. In various aspects, a sauce can be a beverage or dessert sauce such as, for example, a mocha sauce, a caramel sauce, a chocolate sauce, and a coffee sauce. Without wishing to be bound by theory, a sauce tends to be less fluid than a sauce. For this reason, a syrup is typically selected to flavor a cold beverage (e.g., an iced coffee), whereas a sauce is typically selected to flavor a hot beverage (e.g., a hot coffee).

As used herein, the term “coffee” refers to a food product that is made from roasted and/or ground seeds or beans of a coffee plant. For example, the coffee can be made from one or more of Arabica, Robusta, Liberica beans, and Excelsa beans. The coffee can also be roasted such as, for example, a light roast, a medium roast, a dark roast, or an extra dark roast. As used herein, coffee includes, but is not limited to, coffee extracts, expressos, instant coffees, cold brews, hot brews, pour overs, drips, iced coffees, and blended coffees (e.g., cappuccinos, lanes, Americanos, cortados, red eyes, mochas, macchiatos, flat whites, café au laits, irish coffees, Frappuccinos®).

As used herein, the term “tea” refers to a food product that is made by infusing the dried, crushed leaves of a tea plant (e.g., Camellia sinensis). As would be appreciated by one of ordinary skill in the art, the tea can be produced via a variety of different harvesting and processing methods in order to endow the tea with its desired characteristics. Exemplary teas include, but are not limited to, black teas, green teas, passion teas, white teas, Earl Grey teas, matcha teas, oolong teas, pu-erh teas, purple teas, and Chai teas.

### B. Comestible Capsules

In one aspect, disclosed are comestible capsules, comprising: (a) a core composition comprising at least one flavored base component selected from an alternative dairy product, a syrup, a sauce, a coffee, and a tea; and (b) an encapsulation surface comprising a gelled polysaccharide, which encapsulates the core composition.

In one aspect, disclosed are comestible capsules, comprising: (a) a core composition comprising at least one flavored base component and at least two colorants, wherein each colorant has a different color; and (b) an encapsulation surface comprising a gelled polysaccharide, which encapsulates the core composition, wherein the capsule has a marbleized color.

In one aspect, disclosed are comestible capsules prepared by a disclosed method.

As further described here, comestible capsules refer to edible, biodegradable gelatin or gelatin-like structure that are intended to be added to a food product such as a beverage. The disclosed comestible capsules beneficially allow for a variety of different flavors, colors, and textures to be achieved. For example, the disclosed comestible capsules can incorporate a variety of different flavored base components (e.g., alternative dairy products, syrups, sauces, coffees, teas) and/or textured components (e.g., fruit puree, fruit pieces, fresh fruit) therein. The disclosed comestible capsules can also have multiple colors in a single capsule, such that each capsule is unique in color load and pattern. Accordingly, the disclosed comestible capsules can be useful in a wide range of food products such as, for example, beverages (e.g., coffees such as instant coffees, cold brews, hot brews, traditional brews, and blended coffees, teas, fruit juices, smoothies, waters such as still waters and sparkling waters, liquors, liqueurs, mixtures thereof), desserts (e.g., ice creams, flans, cakes, custards, pies, yogurts, shaved ice, tarts), and dough-based food products (e.g., croissants, waffles, pancakes, breads).

In various aspects, the the comestible capsule comprises: (a) a core composition comprising a sugar, a gum, a calcium ion source, and at least one flavored base component selected from an alternative dairy product, a syrup, a sauce, a coffee, and a tea, wherein the core composition is a liquid; and (b) an encapsulation surface comprising a gelled alginate, which encapsulates the core composition, wherein the comestible capsule does not contain a starch, a fruit juice, or a fruit puree. In various further aspects, the core composition consists of the sugar, the gum, the calcium ion source, and the at least one flavored base component.

In various aspects, the comestible capsule comprises: (a) a core composition comprising a sugar, a gelled alginate, and at least one flavored base component selected from an alternative dairy product, a syrup, a sauce, a coffee, and a tea, wherein the core composition is a gel; and (b) an encapsulation surface comprising a gelled alginate and a calcium ion source, which encapsulates the core composition, wherein the comestible capsule does not contain a starch, a fruit juice, or a fruit puree.

In various aspects, the comestible capsule further comprises a fruit juice or fruit puree. In further various aspects, the comestible capsule does not contain a fruit juice or a fruit puree.

In various aspects, the comestible capsule further comprises a starch such as, for example, a tapioca starch or a modified tapioca starch. In various further aspects, the comestible capsule does not contain a tapioca starch or a modified tapioca starch. In various further aspects, the comestible capsule does not contain a starch.

In various aspects, the comestible capsule further comprises a plurality of fruit pieces. In various further aspects, the comestible capsule does not contain a plurality of fruit pieces.

In various aspects, the comestible capsule further comprises an infusing agent, a flavoring agent, a spice, a vitamin, caffeine, a mineral, an herbal supplement, a colorant, or a combination thereof.

In various aspects, the comestible capsule has a color such as, for example, a uniform color or a marbleized. As further detailed herein, the color can be achieved via selection of a flavored base component that has a color or the addition of a colorant to the core composition, or by a combination of these techniques. Thus, in a further aspect, the comestible capsule has a uniform color. In a still further aspect, the comestible capsule has a marbleized color.

In various aspects, the comestible capsule has a shape such as, for example, a round shape, an elliptical shape, or a tear-drop shape, although other shapes are envisioned as well (e.g., heart, shamrock, star, egg, pumpkin, Christmas tree). In various further aspects, the comestible capsule has a maximum length of from about 4 mm to about 8 mm, about 4 mm to about 7 mm, about 4 mm to about 6 mm, about 4 mm to about 5 mm, about 5 mm to about 8 mm, about 6 mm to about 8 mm, about 7 mm to about 8 mm, or about 5 mm to about 7 mm. The comestible capsule a maximum width of from about 4 mm to about 8 mm, about 4 mm to about 7 mm, about 4 mm to about 6 mm, about 4 mm to about 5 mm, about 5 mm to about 8 mm, about 6 mm to about 8 mm, about 7 mm to about 8 mm, or about 5 mm to about 7 mm. In a further aspect, the comestible capsule has a maximum length of from about 5 mm to about 7 mm.

1. Core Compositions

In various aspects, the disclosed comestible capsule comprises a core composition. As disclosed herein, the core composition comprises at least one flavored base component. Examples of flavored base components include, but are not limited to, alternative dairy products, syrups, sauces, coffees, teas, water, fruit juice, and fruit puree. In various further aspects, the core composition does not contain a milk-based dairy product. In various further aspects, the core composition does not contain a fruit juice.

In various aspects, the flavored base component is selected from an alternative dairy product, a syrup, a sauce, a coffee, and a tea. In a further aspect, the flavored base component comprises water. In a still further aspect, the flavored base component comprises a fruit juice or a fruit puree.

In various aspects, the flavored base component comprises an alternative dairy product such as, for example, a dairy milk or a dairy creamer. As detailed herein, an alternative dairy product is a food product that can be used in place of a product that is made from or otherwise contains cow's milk, but does not itself contain cow's milk. In a further aspect, the flavored base component is a dairy milk selected from coconut milk, oak milk, soy milk, almond milk, and chia milk.

In various aspects, the flavored base component is a syrup. As detailed herein, a syrup is a thick, viscous liquid consisting primarily of a solution of sugar in water that is suitable for human consumption. In a further aspect, the syrup is selected from a chocolate syrup, a vanilla syrup, a caramel syrup, a raspberry syrup, a brown sugar syrup, and a cascara syrup.

In various aspects, the flavored base component is a sauce. As detailed herein, a sauce is a thick liquid typically used to add moistness and/or flavor to food that is suitable for human consumption. Examples of sauces include, but are not limited to, white chocolate sauce, chocolate sauce, mocha sauce, pumpkin spice sauce, and caramel sauce. In a further aspect, the sauce is a mocha sauce.

In various aspects, the flavored base component is a coffee. As detailed herein, coffee refers a food product that is made from roasted and/or ground seeds or beans of a coffee plant. In a further aspect, the coffee is selected from a coffee extract, an expresso, an instant coffee, a cold brew, and a hot brew.

In various aspects, the flavored base component is a tea. As detailed herein, tea refers to a food product that is made by infusing the dried, crushed leaves of a tea plant. In a further aspect, the tea is selected from a black tea, a green tea, a passion tea, a white tea, an Earl Grey tea, a matcha tea, and a Chai tea.

In various aspects, the flavored base component has a color. In this way, the overall comestible capsule can similarly have the same color. In aspects in which more than one color is present, as further detailed below, the overall comestible capsule can have a marbleized color. For example, if the flavored base component has a first color and a colorant having a second color is added, wherein the first color and the second color are different, the comestible capsule can have a marbleized color.

In various aspects, the flavored base component is a coffee extract and/or an alternative dairy product, and the core composition further comprises one or more of fresh fruit, fruit juice, fruit puree, and ice. In various further aspects, the core composition comprises a Refresher™.

In various aspects, the core composition further comprises a sugar. In a further aspect, the core composition further comprises more than one sugar. In a still further aspect, the core composition further comprises a single sugar. In yet a further aspect, the sugar is the only sugar in the core composition. In an even further aspect, the sugar is the only sugar in the comestible capsule. Examples of sugars include, but are not limited to, granulated sugar, brown sugar, maple sugar, honey, cascara sugar, and coconut sugar. In a further aspect, the sugar is granulated sugar.

In various aspects, the core composition is a liquid. Such a consistency can be achieved by, for example, the conditions used to prepare the comestible capsule, as further described herein.

In various aspects, the liquid core composition further comprises one or more gums. Examples of gums include, include are not limited to, cassia gum, sesbania gum, tamarind gum, guar gum, xanthan gum, fenugreek gum, gelatin, and Arabic gum. In a further aspects, the core composition further comprises a single gum. In a still further aspect, the core composition comprises a mixture of gums. In yet a further aspect, the core composition comprises a mixture of guar gum and xantham gum.

In various aspects, the liquid core composition further comprises one or more calcium ion sources. In a further aspect, the liquid core composition further comprises a single calcium ion source. In a still further aspect, the liquid core composition further comprises more than one calcium ion sources. In yet a further aspect, the calcium ion source is calcium chloride.

In various aspects, the core composition is a gel. Such a consistency can be achieved by, for example, the conditions used to prepare the comestible capsule, as further described herein.

In various aspects, the gel core composition further comprises the gelled polysaccharide. In a further aspect, the gelled polysaccharide comprises a gelled alginate. In a still further aspect, the gelled polysaccharide consists of a gelled alginate.

In various aspects, the core composition further comprises a fruit juice or fruit puree. In various further aspects, the core composition does not contain a fruit juice or a fruit puree.

In various aspects, the core composition further comprises a starch such as, for example, a tapioca starch or a modified tapioca starch. In various further aspects, the core composition does not contain a tapioca starch or a modified tapioca starch. In various further aspects, the core composition does not contain a starch.

In various aspects, the core composition further comprises a plurality of fruit pieces. In various further aspects, the core composition does not contain a plurality of fruit pieces.

In various further aspects, the core composition further comprises one or more colorants. Without wishing to be bound by theory, the addition of one or more colorants can be used to endow the capsule with a color. For example, if the flavored base component is colorless or otherwise does not contain enough color to impact the overall color of the comestible capsule, the addition of a single colorant can result in the comestible capsule having the same color as that colorant. Alternatively, if the flavored base component has a first color, the addition of a single colorant having a second color, wherein the first color and the second color are different, can result in the comestible capsule having a marbleized color. In various aspects, a marbleized color can also be achieved via addition of two or more colorants to the core composition, wherein each colorant has a different color. For example, if the flavored base component is colorless or otherwise does not contain enough color to impact the overall color of the comestible capsule, the addition of two or more colorants having different colors can result in the comestible capsule having a marbleized color.

Thus, in various aspects, the core composition further comprises a single colorant. In a further aspect, the core composition further comprises more than one colorant. In a still further aspect, the core composition further comprises two colorants. In yet a further aspect, each colorant is a different color.

In various aspects, the core composition further comprises an infusing agent, a flavoring agent, a spice, a vitamin, caffeine, a mineral, an herbal supplement, a colorant, or a combination thereof

2. Encapsulation Surfaces

In a further aspect, the disclosed composition comprises an encapsulation surface. As disclosed herein, the encapsulation surface comprises a gelled polysaccharide. As would be understood by one of ordinary skill in the art, the encapsulation surfaces encapsulates or otherwise contains the core composition.

In various aspects, the encapsulation surface can have the same or substantially the same consistency as the core composition (e.g., gel, gelled, or gel-like). In this aspect, the encapsulation surface further comprises one or more calcium ion sources. In a further aspect, the encapsulation surface further comprises a single calcium ion source. In a still further aspect, the encapsulation surface further comprises more than one calcium ion sources. In yet a further aspect, the calcium ion source is calcium sulphate. Alternatively, in various further aspects, the encapsulation surface can have a different consistency than the core composition (e.g., gelled or gel-like versus liquid). Without wishing to be bound by theory, the consistency of the encapsulation surface relative to the core composition can be controlled by, for example, the conditions used to prepare the comestible capsule, as further described herein.

Thus, in various aspects, the core composition is a liquid and the encapsulation surface comprises a gelled polysaccharide (e.g., a gelled alginate). In various further aspects, the core composition is a gel and the encapsulation surface comprises a gelled polysaccharide (e.g., a gelled alginate) and a calcium ion source (e.g., calcium sulphate).

In various aspects, the gelled polysaccharide comprises a gelled alginate. In various further aspects, the gelled polysaccharide consists of a gelled alginate.

3. Optional Components

In one aspect, the composition further comprises at least one additive. Thus, in various aspects, the disclosed comestible capsule can optionally comprise other active and inactive ingredients typically associated with food products, including, but not limited to, infusing agents, flavoring agents, spices, vitamins, caffeines, minerals, herbal supplements, and colorants.

In a further aspect, the additive is present in an amount of from about 0.01 wt % to about 5 wt %, based on the total wt % of the comestible capsule. In a still further aspect, the additive is present in an amount of from about 0.1 wt % to about 5 wt %, based on the total wt % of the comestible capsule. In yet a further aspect, the additive is present in an amount of from about 1 wt % to about 5 wt %, based on the total wt % of the comestible capsule. In an even further aspect, the additive is present in an amount of from about 1.5 wt % to about 5 wt %, based on the total wt % of the comestible capsule. In a still further aspect, the additive is present in an amount of from about 3 wt % to about 5 wt %, based on the total wt % of the comestible capsule. In yet a further aspect, the additive is present in an amount of from about 0.01 wt % to about 3 wt %, based on the total wt % of the comestible capsule. In an even further aspect, the additive is present in an amount of from about 0.01 wt % to about 1.5 wt %, based on the total wt % of the comestible capsule. In yet a further aspect, the additive is present in an amount of from about 0.01 wt % to about 1 wt %, based on the total wt % of the comestible capsule. In an even further aspect, the additive is present in an amount of from about 0.01 wt % to about 0.1 wt %, based on the total wt % of the comestible capsule. In a still further aspect, the additive is present in an amount of from about 0.1 wt % to about 3 wt %, based on the total wt % of the comestible capsule. In yet a further aspect, the additive is present in an amount of from about 1 wt % to about 3 wt %, based on the total wt % of the comestible capsule.

In a further aspect, the additive is present in an amount of less than about 0.01 wt %, based on the total wt % of the comestible capsule. In a still further aspect, the additive is present in an amount of about 0.1 wt %, based on the total wt % of the comestible capsule. In yet a further aspect, the additive is present in an amount of about 1.0 wt %, based on the total wt % of the comestible capsule. In an even further aspect, the additive is present in an amount of about 1.1 wt %, based on the total wt % of the comestible capsule. In a still further aspect, the additive is present in an amount of about 1.2 wt %, based on the total wt % of the comestible capsule. In yet a further aspect, the additive is present in an amount of about 1.3 wt %, based on the total wt % of the comestible capsule. In an even further aspect, the additive is present in an amount of about 1.4 wt %, based on the total wt % of the comestible capsule. In a still further aspect, the additive is present in an amount of about 1.5 wt %, based on the total wt % of the comestible capsule. In yet a further aspect, the additive is present in an amount of about 1.6 wt %, based on the total wt % of the comestible capsule. In an even further aspect, the additive is present in an amount of about 1.7 wt %, based on the total wt % of the comestible capsule. In a still further aspect, the additive is present in an amount of about 1.8 wt %, based on the total wt % of the comestible capsule. In yet a further aspect, the additive is present in an amount of about 1.9 wt %, based on the total wt % of the comestible capsule. In an even further aspect, the additive is present in an amount of about 2.0 wt %, based on the total wt % of the comestible capsule. In a still further aspect, the additive is present in an amount of about 3.0 wt %, based on the total wt % of the comestible capsule. In yet a further aspect, the additive is present in an amount of about 4.0 wt %, based on the total wt % of the comestible capsule. In an even further aspect, the additive is present in an amount of about 5.0 wt %, based on the total wt % of the comestible capsule.

In various aspects, the additive is an infusing agent. As used herein, the term “infusing agent” refers to an additive that binds water to the core composition and/or the encapsulation surface. Examples of infusing agents include, but are not limited to, sodium polyphosphate, soy protein, sodium acid pyrophosphate and polyphosphate.

In various aspects, the additive is a flavoring agent. As used herein, the term “flavoring agent” refers to an additive that can be used to provide an additional taste or flavor. A flavoring agent can also be used, for example, to mask an unpleasant taste. Examples of flavoring agents include, but are not limited to, almond, anise, celery, cassia or cinnamon, clove, lemon, nutmeg, orange, rosemary, savory, basil, sweet marjoram, maple, molasses, passion fruit, lychee, mango, papaya, strawberry, raspberry, chocolate, coffee, red bean, mung bean, tarothyme, and wintergreen.

In various aspects, the additive is a spice. As used herein, the term “spice” refers to an aromatic or pungent vegetable additive that can be used to provide an additional flavor. Examples of spices include, but are not limited to, cardamom, cinnamon, allspice, cloves, nutmeg, pepper, turmeric, ginger, mace, saffron, vanilla, cumin, and dill seed.

In various aspects, the additive is a vitamin. As used herein, the term “vitamin” refers to an organic compound that is essential for normal growth and nutrition, and is required, at least in some quantities, in the human diet. Examples of vitamins include, but are not limited to, vitamin A, vitamin C, vitamin D, vitamin E, vitamin K, choline, thiamin, riboflavin, niacin, pantothenic acid, biotin, vitamin B6, vitamin B12, and folate/folic acid.

In various aspects, the additive is caffeine.

In various aspects, the additive is a mineral. As used herein, the term “mineral” refers to elements found in food products that are essential for normal growth and nutrition, and that do not contain carbon. Examples of minerals include, but are not limited to, calcium, phosphorus, potassium, sodium, chloride, magnesium, iron, zinc, iodine, chromium, copper, fluoride, molybdenum, manganese, and selenium.

In various aspects, the additive is an herbal supplement. As used herein, the term “herbal supplement” refers to an additive that is derived from a plant or plant component (e.g., oils, roots, seeds, berries, flowers). Examples of herbal supplements include, but are not limited to, ginseng, sage, guarana, bacopa monnieri, peppermint, rosemary, Rhodiola rosea, ashwagandha, gotu kola, maca, saw palmetto, black cohjosh, Echinacea, garlic, ginkgo, and St. John's wort.

In various aspects, the additive is colorant. As used herein, the term “colorant” refers to a dye, pigment, or other substance that imparts color and that is acceptable for human consumption, per conventional standards. Examples of colorants include, but are not limited to, natural colorants such as spirulina (blue), turmeric (yellow), and beet (red), or a combination thereof.

### C. Methods of Making a Comestible Capsule

In one aspect, disclosed are methods of making a disclosed comestible capsule, the method comprising: (a) providing the core composition; and (b) dispensing the core composition dropwise into a bath comprising an encapsulating agent, thereby forming an encapsulation surface, provided that: if the core composition comprises a polysaccharide, then the encapsulating agent is a calcium ion source, and if the core composition comprises a calcium ion source, then the encapsulating agent is a polysaccharide.

In one aspect, disclosed are methods of making a disclosed comestible capsule, the method comprising: (a) providing the core composition; (b) sequentially adding a first colorant and a second colorant dropwise into the core composition, wherein the second colorant has a different color than the first colorant, thereby forming a marbleized core composition; and (c) dispensing the marbleized core composition dropwise into a bath, thereby forming the encapsulation surface, provided that: if the core composition comprises a polysaccharide, then the encapsulating agent is a calcium ion source, and if the core composition comprises a calcium ion source, then the encapsulating agent is a polysaccharide.

In various aspects, the comestible capsule comprises: (a) a core composition comprising at least one flavored base component selected from an alternative dairy product, a syrup, a sauce, a coffee, and a tea; and (b) an encapsulation surface comprising a gelled polysaccharide, which encapsulates the core composition.

In various aspects, the comestible capsule comprises: (a) a core composition comprising at least one flavored base component and at least two colorants, wherein each colorant has a different color; and (b) an encapsulation surface comprising a gelled polysaccharide, which encapsulates the core composition, wherein the capsule has a marbleized color.

In various aspects, the core composition comprises at least one flavored base component selected from an alternative dairy product, a syrup, a sauce, a coffee, and a tea. In various further aspects, the core composition does not contain a milk-based dairy product.

In various aspects, the core composition further comprises a sugar. Examples of sugars include, but are not limited to, granulated sugar, brown sugar, maple sugar, honey, cascara sugar, and coconut sugar. In a further aspect, the sugar is granulated sugar. In a further aspect, the core composition further comprises more than one sugar. In a still further aspect, the core composition further comprises a single sugar. In yet a further aspect, the sugar is the only sugar in the core composition. In an even further aspect, the sugar is the only sugar in the comestible capsule.

In various aspects, the sugar is present in an amount of from about 10 wt % to about 30 wt % based on the total weight of the core composition. In a further aspect, the sugar is present in an amount of from about 10 wt % to about 25 wt % based on the total weight of the core composition. In a still further aspect, the sugar is present in an amount of from about 10 wt % to about 20 wt % based on the total weight of the core composition. In yet a further aspect, the sugar is present in an amount of from about 10 wt % to about 15 wt % based on the total weight of the core composition. In an even further aspect, the sugar is present in an amount of from about 15 wt % to about 30 wt % based on the total weight of the core composition. In a still further aspect, the sugar is present in an amount of from about 20 wt % to about 30 wt % based on the total weight of the core composition. In yet a further aspect, the sugar is present in an amount of from about 25 wt % to about 30 wt % based on the total weight of the core composition. In an even further aspect, the sugar is present in an amount of from about 15 wt % to about 25 wt % based on the total weight of the core composition. In a still further aspect, the sugar is present in an amount of about 18 wt % based on the total weight of the core composition.

In various aspects, the core composition further comprises one or more gums. Examples of gums include, include are not limited to, cassia gum, sesbania gum, tamarind gum, guar gum, xanthan gum, fenugreek gum, gelatin, and Arabic gum. In a further aspects, the core composition further comprises a single gum. In a still further aspect, the core composition comprises a mixture of gums. In yet a further aspect, the core composition comprises a mixture of guar gum and xantham gum.

In various aspects, the gum is present in an amount of from about 0.5 wt % to about 1.0 wt % based on the total weight of the core composition. In a further aspect, the gum is present in an amount of from about 0.5 wt % to about 0.9 wt % based on the total weight of the core composition. In a still further aspect, the gum is present in an amount of from about 0.5 wt % to about 0.8 wt % based on the total weight of the core composition. In yet a further aspect, the gum is present in an amount of from about 0.5 wt % to about 0.7 wt % based on the total weight of the core composition. In an even further aspect, the gum is present in an amount of from about 0.5 wt % to about 0.6 wt % based on the total weight of the core composition. In a still further aspect, the gum is present in an amount of from about 0.6 wt % to about 1.0 wt % based on the total weight of the core composition. In yet a further aspect, the gum is present in an amount of from about 0.7 wt % to about 1.0 wt % based on the total weight of the core composition. In an even further aspect, the gum is present in an amount of from about 0.8 wt % to about 1.0 wt % based on the total weight of the core composition. In a still further aspect, the gum is present in an amount of from about 0.9 wt % to about 1.0 wt % based on the total weight of the core composition. In yet a further aspect, the gum is present in an amount of from about 0.6 wt % to about 0.9 wt % based on the total weight of the core composition. In an even further aspect, the gum is present in an amount of from about 0.7 wt % to about 0.8 wt % based on the total weight of the core composition. In a still further aspect, the gum is present in an amount of about 0.7 wt % based on the total weight of the core composition.

In various aspects, the core composition comprises the calcium ion source and the encapsulating agent is the polysaccharide. Without wishing to be be bound by theory, when the core composition comprises the calcium ion source and the encapsulating agent is the polysaccharide, the resultant comestible capsules can have a thin, gel-like skin (e.g., an encapsulating surface) with a flavored base component contained therein that bursts when squeezed (e.g., a popping boba pearl). Thus, in various aspects, the calcium ion source is calcium chloride. In various further aspects, the polysaccharide is an alginate.

In various aspects, wherein the calcium ion source is present in an amount of from about 0.1 wt % to about 0.5 wt % based on the total weight of the core composition. In a further aspect, wherein the calcium ion source is present in an amount of from about 0.1 wt % to about 0.4 wt % based on the total weight of the core composition. In a still further aspect, wherein the calcium ion source is present in an amount of from about 0.1 wt % to about 0.3 wt % based on the total weight of the core composition. In yet a further aspect, wherein the calcium ion source is present in an amount of from about 0.1 wt % to about 0.2 wt % based on the total weight of the core composition. In an even further aspect, wherein the calcium ion source is present in an amount of from about 0.2 wt % to about 0.5 wt % based on the total weight of the core composition. In a still further aspect, wherein the calcium ion source is present in an amount of from about 0.3 wt % to about 0.5 wt % based on the total weight of the core composition. In yet a further aspect, wherein the calcium ion source is present in an amount of from about 0.4 wt % to about 0.5 wt % based on the total weight of the core composition. In an even further aspect, wherein the calcium ion source is present in an amount of from about 0.2 wt % to about 0.4 wt % based on the total weight of the core composition. In a still further aspect, wherein the calcium ion source is present in an amount of about 0.2 wt % based on the total weight of the core composition.

In various aspects, the core composition comprises the polysaccharide and the encapsulating agent is the calcium ion source. Without wishing to be be bound by theory, when the core composition comprises the polysaccharide and the encapsulating agent is the calcium ion source, the resultant comestible capsules can have a thicker outer membrane (e.g., encapsulating surface) with gel-like consistency throughout (e.g., a solid boba pearl). Thus, in various aspects, the polysaccharide is an alginate. In various further aspects, the calcium ion source is calcium sulfate.

In various aspects, the polysaccharide is present in an amount of from about 0.5 wt % to about 5.0 wt % based on the total weight of the core composition. In a further aspect, the polysaccharide is present in an amount of from about 0.5 wt % to about 4.0 wt % based on the total weight of the core composition. In a still further aspect, the polysaccharide is present in an amount of from about 0.5 wt % to about 3.0 wt % based on the total weight of the core composition. In yet a further aspect, the polysaccharide is present in an amount of from about 0.5 wt % to about 2.0 wt % based on the total weight of the core composition. In an even further aspect, the polysaccharide is present in an amount of from about 0.5 wt % to about 1.0 wt % based on the total weight of the core composition. In a still further aspect, the polysaccharide is present in an amount of from about 1.0 wt % to about 5.0 wt % based on the total weight of the core composition. In yet a further aspect, the polysaccharide is present in an amount of from about 2.0 wt % to about 5.0 wt % based on the total weight of the core composition. In an even further aspect, the polysaccharide is present in an amount of from about 3.0 wt % to about 5.0 wt % based on the total weight of the core composition. In a still further aspect, the polysaccharide is present in an amount of from about 4.0 wt % to about 5.0 wt % based on the total weight of the core composition. In yet a further aspect, the polysaccharide is present in an amount of from about 1.0 wt % to about 4.0 wt % based on the total weight of the core composition. In an even further aspect, the polysaccharide is present in an amount of from about 2.0 wt % to about 3.0 wt % based on the total weight of the core composition. In a still further aspect, the polysaccharide is present in an amount of about 1.5 wt % based on the total weight of the core composition.

In various aspects, the the at least one flavored base component is present in an amount of from about 70 wt % to about 90 wt % based on the total weight of the core composition. In a further aspect, the at least one flavored base component is present in an amount of from about 70 wt % to about 85 wt % based on the total weight of the core composition. In a still further aspect, the at least one flavored base component is present in an amount of from about 70 wt % to about 80 wt % based on the total weight of the core composition. In yet a further aspect, the at least one flavored base component is present in an amount of from about 70 wt % to about 75 wt % based on the total weight of the core composition. In an even further aspect, the at least one flavored base component is present in an amount of from about 75 wt % to about 90 wt % based on the total weight of the core composition. In a still further aspect, the at least one flavored base component is present in an amount of from about 80 wt % to about 90 wt % based on the total weight of the core composition. In yet a further aspect, the at least one flavored base component is present in an amount of from about 85 wt % to about 90 wt % based on the total weight of the core composition. In an even further aspect, the at least one flavored base component is present in an amount of from about 75 wt % to about 85 wt % based on the total weight of the core composition. In a still further aspect, the at least one flavored base component is present in an amount of about 80 wt % based on the total weight of the core composition.

In various aspects, the core composition comprises a sugar, a gum, the calcium ion source, and the at least one flavored base component, wherein the encapsulating agent is the polysaccharide, and wherein the core composition is a liquid after the dispensing step. In a further aspect, the sugar is granulated sugar, the gum is a combination of guar gum and xanthan gum, the salt is calcium chloride, and the polysaccharide is an alginate.

In various aspects, the sugar, the gum, and the calcium ion source are pre-mixed to form a dry blend prior to mixing with the at least one flavored base component. In a further aspect, mixing is via a mixer. In a still further aspect, mixing is at medium-low speed. In yet a further aspect, mixing is at a speed of from about 550 rpm to about 850 rpm. In an even further aspect, mixing is at a speed of from about 550 rpm to about 800 rpm. In a still further aspect, mixing is at a speed of from about 550 rpm to about 750 rpm. In yet a further aspect, mixing is at a speed of from about 550 rpm to about 700 rpm. In an even further aspect, mixing is at a speed of from about 550 rpm to about 650 rpm. In a still further aspect, mixing is at a speed of from about 550 rpm to about 600 rpm. In yet a further aspect, mixing is at a speed of from about 600 rpm to about 850 rpm. In an even further aspect, mixing is at a speed of from about 650 rpm to about 850 rpm. In a still further aspect, mixing is at a speed of from about 700 rpm to about 850 rpm. In yet a further aspect, mixing is at a speed of from about 750 rpm to about 850 rpm. In an even further aspect, mixing is at a speed of from about 750 rpm to about 850 rpm. In a still further aspect, mixing is at a speed of from about 600 rpm to about 800 rpm. In yet a further aspect, mixing is at a speed of from about 650 rpm to about 750 rpm.

In various aspects, the core composition comprises a sugar, the polysaccharide, and the at least one flavored base component, wherein the encapsulating agent is the calcium ion source, and wherein the core composition is a gel after the dispensing step. In a further aspect, the sugar is granulated sugar, the polysaccharide is an alginate, and the calcium ion source is calcium sulfate.

In various aspects, the sugar and the polysaccharide are pre-mixed to form a dry blend prior to mixing with the at least one flavored base component. In a further aspect, mixing is via a mixer. In a still further aspect, mixing is at medium-low speed. In yet a further aspect, mixing is at a speed of from about 550 rpm to about 850 rpm. In an even further aspect, mixing is at a speed of from about 550 rpm to about 800 rpm. In a still further aspect, mixing is at a speed of from about 550 rpm to about 750 rpm. In yet a further aspect, mixing is at a speed of from about 550 rpm to about 700 rpm. In an even further aspect, mixing is at a speed of from about 550 rpm to about 650 rpm. In a still further aspect, mixing is at a speed of from about 550 rpm to about 600 rpm. In yet a further aspect, mixing is at a speed of from about 600 rpm to about 850 rpm. In an even further aspect, mixing is at a speed of from about 650 rpm to about 850 rpm. In a still further aspect, mixing is at a speed of from about 700 rpm to about 850 rpm. In yet a further aspect, mixing is at a speed of from about 750 rpm to about 850 rpm. In an even further aspect, mixing is at a speed of from about 750 rpm to about 850 rpm. In a still further aspect, mixing is at a speed of from about 600 rpm to about 800 rpm. In yet a further aspect, mixing is at a speed of from about 650 rpm to about 750 rpm.

In various aspects, the bath has a depth of at least about 3.0 inches. Without wishing to be bound by theory, the depth of the bath can impact the formation of the capsule. To produce capsules in which the core composition is liquid, for example, the core composition must be dropped with enough force to create a pocket around the flavored base component. Thus, the depth of the bath can help to achieve the requisite force. In a further aspect, the bath has a depth of at least about 3.5 inches. In a still further aspect, the bath has a depth of at least about 4.0 inches. In yet a further aspect, the bath has a depth of at least about 4.5 inches. In an even further aspect, the bath has a depth of at least about 5.0 inches. In a still further aspect, the bath has a depth of greater than about 5.0 inches.

In various aspects, the method further comprises preparing the bath by mixing the encapsulating agent and water. As detailed herein, the bath can have an area that is large enough to allow for space between the capsules so that they do not touch or otherwise clump together. This can also be accomplished by dispensing droplets of the core composition such that each droplet is spaced apart.

In various aspects, the core composition is dispensed via a pipette. In various further aspects, the core composition is dispensed from a height of at least about 7 inches above the surface. Without wishing to be bound by theory, the height from which the core composition is dispensed can also impact the formation of the capsule. As detailed above, capsules having a liquid core composition must be dropped with sufficient force to create a pocket. Thus, the height from which the core composition is dispensed can also help to achieve the requisite force. In a further aspect, the core composition is dispensed from a height of at least about 7.5 inches above the surface. In a still further aspect, the core composition is dispensed from a height of at least about 8 inches above the surface. In yet a further aspect, the core composition is dispensed from a height of at least about 8.5 inches above the surface. In an even further aspect, the core composition is dispensed from a height of at least about 9 inches above the surface. In a still further aspect, the core composition is dispensed from a height of at least about 9.5 inches above the surface. In yet a further aspect, the core composition is dispensed from a height of at least about 10 inches above the surface.

In various aspects, the core composition remains in the bath for a time period of at least about 40 minutes. Without wishing to be bound by theory, the core composition should remain in the bath for enough time to allow the capsule to gel. Moreover, the time period can be changed based on the desired consistency of the capsule. For example, for capsules having a liquid core composition and a gel-like encapsulation surface (e.g., a popping boba pearl), a time period of from about 15 minutes to about 30 minutes, about 15 minutes to about 25 minutes, about 15 minutes to about 20 minutes, about 20 minutes to about 30 minutes, about 25 minutes to about 30 minutes, or about 20 minutes to about 25 minutes can be selected. Thus, in a further aspect, the core composition remains in the bath for a time period of less than about 30 minutes. In a still further aspect, the core composition remains in the bath for a time period of from about 15 minutes to about 20 minutes. Alternatively, for capsules having a gel-like consistency throughout (e.g., a solid boba pearl), a time period of from about 30 minutes to about 2.5 hours, about 30 minutes to about 2.0 hours, about 30 minutes to about 1.5 hours, about 30 minutes to about 1.0 hour, about 1.0 hour to about 2.5 hours, 1.5 hours to about 2.5 hours, about 2.0 hours to about 2.5 hours, or about 1.0 hour to about 2.0 hours can be selected. Thus, in a further aspect, the core composition remains in the bath for a time period of at least about 40 minutes. In a still further aspect, the core composition remains in the bath for a time period of no more than about 2 hours.

In various aspects, the method further comprises straining the capsule. In various further aspects, the method further comprises rinsing the capsule.

In various aspects, the method comprises: (a) mixing granulated a sugar, a gum, and the calcium ion source, thereby forming a dry blend; (b) mixing the dry blend and the at least one flavored base component, thereby forming the core composition; (c) dispensing the core composition dropwise into a bath having a surface and a depth of at least about 5.0 inches, wherein the core composition is dispensed from a height of at least about 8.0 inches above the surface, and wherein the encapsulating agent is the polysaccharide, thereby forming the encapsulation surface; and (d) straining the capsule, wherein the core composition is a liquid after the dispensing step, and wherein the core composition remains in the bath for a time period of less than about 30 minutes. In a further aspect, the method further comprises rinsing the capsule after the straining step.

In various aspects, the method comprises: (a) mixing a sugar and the polysaccharide, thereby forming a dry blend; (b) mixing the dry blend and at least one flavored base component, thereby forming the core composition; (c) dispensing the core composition dropwise into the bath, wherein the encapsulating agent is a calcium ion source, thereby forming the encapsulation surface; and (d) straining the capsule, wherein the core composition is a gel after the dispensing step, and wherein the core composition remains in the bath for a time period of from about 40 minutes to about 2 hours. In a further aspect, the method further comprises rinsing the capsule after the straining step.

In various aspects, the method further comprises adding a first colorant dropwise into the core composition prior to the dispensing step. As detailed above, the addition of one or more colorants can be used to endow the capsule with a color. For example, if the flavored base component is colorless or otherwise does not contain enough color to impact the overall color of the comestible capsule, the addition of a single colorant can result in the comestible capsule having the same color as that colorant. Thus, in various aspects, the capsule has a uniform or substantially uniform color. Alternatively, if the flavored base component has a first color, the addition of a single colorant having a second color, wherein the first color and the second color are different, can result in the comestible capsule having a marbleized color. Thus, in various aspects, the capsule has a marbleized color.

In various aspects, the method further comprises adding a second colorant dropwise into the core composition prior to the dispensing step, wherein the second colorant is a different color than the first colorant. As detailed above, if the flavored base component is colorless or otherwise does not contain enough color to impact the overall color of the comestible capsule, the addition of two or more colorants having different colors can result in the comestible capsule having a marbleized color. Thus, in various aspects, the capsule has a marbleized color.

In various aspects, the method further comprises adding a plurality of fruit pieces to the core composition.

In various aspects, the method further comprises adding one or more selected from an infusing agent, a flavoring agent, a spice, a vitamin, caffeine, a mineral, an herbal supplement, and a colorant to the core composition.

### D. Food Products

In one aspect, disclosed are compositions comprising a plurality of the disclosed comestible capsules, wherein the composition is a food product. Examples of food products include, but are not limited to, beverages (e.g., coffees such as instant coffees, cold brews, hot brews, traditional brews, and blended coffees, teas, fruit juices, smoothies, waters such as still waters and sparkling waters, liquors, liqueurs, mixtures thereof), desserts (e.g., ice creams, flans, cakes, custards, pies, yogurts, shaved ice, tarts), and dough-based food products (e.g., croissants, waffles, pancakes, breads). In a further aspect, the food product is a beverage. In a still further aspect, the beverage is a coffee (e.g., instant coffee, cold brew, hot brew, traditional brew, blended coffee), a tea, a fruit juice, a smoothie, or a water (e.g., still, sparkling).

In one aspect, disclosed are composition comprising a plurality of comestible capsules, wherein the composition is a food product, and wherein the comestible capsules were prepared by a disclosed method.

In various aspects, the comestible capsule comprises: (a) a core composition comprising at least one flavored base component selected from an alternative dairy product, a syrup, a sauce, a coffee, and a tea; and (b) an encapsulation surface comprising a gelled polysaccharide, which encapsulates the core composition.

In various aspects, the comestible capsule comprises: (a) a core composition comprising at least one flavored base component and at least two colorants, wherein each colorant has a different color; and (b) an encapsulation surface comprising a gelled polysaccharide, which encapsulates the core composition, wherein the capsule has a marbleized color.

Without wishing to be bound by theory, a disclosed comestible capsule can be used to add flavor to a food product, to change the texture of the food product, and/or to change the visual appearance of the food product. For example, a disclosed comestible capsule can be used to add a dairy alternative or espresso to a coffee or dessert. Alternatively, a disclosed comestible capsule can be used to add a flavor to a sparkling water. A disclosed comestible capsule can also be used to change the visual appearance of the food product to reflect, for example, a holiday (e.g., red and green marbleized comestible capsule), a sports team, or a flavor (e.g., pink and green marbleized comestible capsule to denote watermelon flavor). Combinations of these effects are envisioned as well.

In various aspects, the food product is a coffee. In various further aspects, the coffee can be made from one or more of Arabica, Robusta, Liberica beans, and Excelsa beans. In various further aspects, the coffee can be roasted (e.g., a light roast, a medium roast, a dark roast, an extra dark roast). Examples of coffees include, but are not limited to, expressos, instant coffees, cold brews, hot brews, pour overs, drips, iced coffees, and blended coffees (e.g., cappuccinos, lattes, Americanos, cortados, red eyes, mochas, macchiatos, flat whites, café au laits, irish coffees, Frappuccinos®).

In various aspects, the food product is a tea. Examples of teas include, but are not limited to, black teas, green teas, passion teas, white teas, Earl Grey teas, matcha teas, oolong teas, pu-erh teas, purple teas, and Chai teas.

In various aspects, the food product is a fruit juice. Examples of fruit juices include, but are not limited to, apple juice, cranberry juice, grape juice, orange juice, grapefruit juice, blueberry juice, kiwi juice, starfruit juice, drangfruit juice, mango juice, acai juice, lemonade, and combinations thereof. In various aspects, the fruit juice further comprises additional components such as, for example, an alternative dairy product (e.g., coconut milk), coffee extract, ice, fresh fruit, and/or fruit puree. In various further aspects, the fruit juice is a Refresher™.

In various aspects, the food product is a smoothie. Examples of smoothies include, but are not limited to, orange smoothies, blueberry smoothies, kiwi smoothies, starfruit smoothies, drangfruit smoothies, mango smoothies, acai smoothies, lemonade, banana smoothies, and combinations thereof.

In various aspects, the food product is a water such as, for example, still water or sparkling water.

### E. Experimental

The following examples are put forth so as to provide those of ordinary skill in the art with a complete disclosure and description of how the compounds, compositions, articles, devices and/or methods claimed herein are made and evaluated, and are intended to be purely exemplary and are not intended to limit the disclosure. Efforts have been made to ensure accuracy with respect to numbers (e.g., amounts, temperature, etc.), but some errors and deviations should be accounted for. Unless indicated otherwise, parts are parts by weight, temperature is in ° C. or is at ambient temperature, and pressure is at or near atmospheric.

1. Preparation of Popping Pearls

A summary of the ingredients used to prepare popping pearls is shown in Tables 1A and 1B below.

TABLE 1A

| Formulation | Flavored Base | Flavored Base |
|---|---|---|
| No. | Component #1 | Component #2 |
| 1* | Coconut milk | — |
| 2 | Oat milk | — |
| 3 | Soy | — |
| 4 | Almond | — |
| 5 | Chia (MDF) | — |
| 6 | Big Boba | — |
| 7 | Perfect puree | — |
| 8 | Marbled | — |
| 9 | Shaped | — |
| 10 | Vanilla sweet cream | — |
| 11 | Chai | Oatmilk |
| 12 | Blonde Espresso | Oatmilk |
| 13 | Matcha Latte (oat milk) | — |
| 14 | Oat milk | — |
| 15 | Soy | — |
| 16 | Almond | — |

*Indicates a marbleized formulation.

TABLE 1B

| | Flavored | Flavored | Action | | |
|---|---|---|---|---|---|
| | Base | Base | Gum | | Calcium |
| Formulation | Component | Component | 10000 | Sugar | Chloride |
| No. | #1 (g) | #2 (g) | EC (g) | (g) | (g) |
| 1 | 80 | — | 0.68 | 18.18 | 0.23 |
| 2 | 80 | — | 0.68 | 18.18 | 0.23 |
| 3 | 80 | — | 0.68 | 18.18 | 0.23 |
| 4 | 80 | — | 0.68 | 18.18 | 0.23 |
| 5 | 80 | — | 0.68 | 18.18 | 0.23 |
| 6 | 80 | — | 0.68 | 18.18 | 0.23 |
| 7 | 80 | — | 0.68 | 18.18 | 0.23 |
| 8 | 80 | — | 0.68 | 18.18 | 0.23 |
| 9 | 80 | — | 0.68 | 18.18 | 0.23 |
| 10 | 80 | — | 0.68 | 18.18 | 0.23 |
| 11 | 40 | 40 | 0.68 | 18.18 | 0.23 |
| 12 | 20 | 60 | 0.68 | 18.18 | 0.23 |
| 13 | 80 | — | 0.68 | 18.18 | 0.23 |
| 14 | 80 | — | 0.68 | 18.18 | 0.23 |
| 15 | 80 | — | 0.68 | 18.18 | 0.23 |
| 16 | 80 | — | 0.68 | 18.18 | 0.23 |

Referring to the preparation of formulation nos. 1-16 above, the sugar, Action Gum 10000 EC, and calcium chloride were dry blended. The dry blend was then added to the flavored base component using a mixer. The resultant mixture was mixed on medium-low-speed (600-800 rpm) to minimize air bubbles. The alginate bath was then prepared in a separate container by mixing TICA-algin HG 400 in water. It can take up to one hour to fully incorporate. The alginate bath should be at least 5 inches deep. Next, pearls of the liquid mixture (dry blend+flavored base component) were dispensed via a pipette into the alginate bath from approximately 10 inches above the surface of the bath. When dispensing, care should be taken to leave space between the pearls to prevent them from sticking together. After approximately 15 minutes in the bath, the pearls were strained and rinsed under running water to remove excess alginate.

All of the formulations above were evaluated on a “Pass/Fail” rating scale based on their ability to form an encapsulated pearl with a liquid center. If the formula was successful, it received a “Pass.” If it did not gel to form an outside layer with a liquid center, it received a “Fail.” Of exemplary formulation nos. 1-15, only formulation no. 9 failed. All others received a “Pass” rating.

2. Preparation of Solid Pearls

A summary of the ingredients used to prepare solid pearls is shown in Tables 2A and 2B below.

TABLE 2A

| Formulation No. | Flavored Base Component |
|---|---|
| 17 | Chai |
| 18 | Lemonade |
| 19 | Oat milk |
| 20 | Mango dragonfruit |
| 21 | Mango dragonfruit (squints) |
| 22 | Black tea |
| 23 | Passion tea |
| 24 | Green tea |
| 25 | Almond milk |
| 26 | Caramel syrup |
| 27 | Vanilla syrup |
| 28 | Strawberry puree |
| 29 | Peach juice |
| 30 | Apple juice |
| 31 | Lemonade |
| 32 | Chai |
| 33 | Mocha |
| 34 | Blueberry juice |
| 35 | Cherry |
| 36 | Guave |
| 37 | Coconut milk |
| 38 | Soy |
| 39 | Not milk |
| 40 | Strawberry aci |
| 41 | Kiwi |
| 42 | Mocha |
| 43 | Caramel |
| 44 | Pineapple ginger |
| 45 | Honey |
| 46 | Kiwi Refresher ™ with inclusion |

TABLE 2B

| | | | | Time in |
|---|---|---|---|---|
| Formulation | Flavored Base | A400 Powder | Sugar | solution |
| No. | Component (g) | (g) | (g) | (h:min)* |
| 17 | 80 | 1.5 | 18.18 | 2:00 |
| 18 | 80 | 1.5 | 18.18 | — |
| 19 | 80 | 1.5 | 18.18 | 0:40 |
| 20 | 80 | 1.5 | 18.18 | 1:20 |
| 21 | 80 | 1.5 | 18.18 | — |
| 22 | 80 | 1.5 | 18.18 | 1:00 |
| 23 | 80 | 1.5 | 18.18 | 0:40 |
| 24 | 80 | 1.5 | 18.18 | — |
| 25 | 80 | 1.5 | 18.18 | 1:00 |
| 26 | 80 | 1.5 | 18.18 | 2:00 |
| 27 | 40 | 1.5 | 18.18 | 2:00 |
| 28^{a} | 20 | 1.5 | 18.18 | — |
| 29 | 80 | 1.5 | 18.18 | — |
| 30 | 80 | 1.5 | 18.18 | 1:00 |
| 31 | 80 | 6 | 30 | — |
| 32 | 80 | 3 | 25 | 1:00 |
| 33 | 80 | 1.5 | 18 | 1:45 |
| 34^{b} | 80 | 1.5 | 18 | 1:00 |
| 35^{c} | 80 | 1.5 | 18 | 1:00 |
| 36 | 80 | 1.5 | 18 | — |
| 37 | 80 | 1.5 | 18 | 1:20 |
| 38 | 80 | 1.5 | 18 | 1:45 |
| 39 | 80 | 1.5 | 18 | — |
| 40 | 80 | 1.5 | 18 | — |
| 41 | 80 | 1.5 | 18 | 1:00 |
| 42^{c} | 80 | 2 | 18 | — |
| 43 | 80 | 1.5 | 18 | — |
| 44 | 80 | 1.5 | 18 | — |
| 45 | 80 | 1.5 | 18 | — |
| 46^{d} | 130 | 1.5 | 18 | 1:00 |

^{a}85 grams of water was added to the solution due to the consistency.
^{b}50 grams of water were added.
^{c}25 grams of water were added.
^{d}5 gram of crushed FD kiwi pieces were added. This necessitated the addition of additional liquid.
^{e} Formulations were maintained in the bath for up to 2 hours. Formulations listed as “—” did not gel all the way through to the center to form a solid pearl after 2 hours.

Referring to the preparation of formulation nos. 17-46 above, the sugar and TICA-algin 400 powder were dry blended. The dry blend was then added to the flavored base component using a mixer. The resultant mixture was mixed on medium-low-speed (600-800 rpm) to minimize air bubbles. A calcium bath was prepared in a separate container. Next, pearls of the gum/flavored base mixture (dry blend+flavored base component) were dispensed via a pipette into the calcium sulfate solution. The pearls were allowed to gel in the solution for the indicated time until the centers were firm. Finally, the pearls were strained and rinsed under running water to remove excess alginate.

All of the formulations above were evaluated on a “Pass/Fail” rating scale as detailed above. Their respective ratings are illustrated below in Table 3.

TABLE 3

| Formulation No. | Rating |
|---|---|
| 17 | Pass |
| 18 | Fail |
| 19 | Pass |
| 20 | Pass |
| 21 | Fail |
| 22 | Pass |
| 23 | Pass |
| 24 | Pass |
| 25 | Pass |
| 26 | Pass |
| 27 | Pass |
| 28 | Fail |
| 29 | Fail |
| 30 | Pass |
| 31 | Fail |
| 32 | Pass |
| 33 | Pass |
| 34 | Pass |
| 35 | Pass |
| 36 | Fail |
| 37 | Pass |
| 38 | Pass |
| 39 | Pass |
| 40 | Pass |
| 41 | Pass |
| 42 | Fail |
| 43 | Fail |
| 44 | Fail |
| 45 | Fail |
| 46 | Pass |

It will be apparent to those skilled in the art that various modifications and variations can be made in the present invention without departing from the scope or spirit of the invention. Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A comestible capsule, comprising:
(a) a core composition comprising at least one flavored base component selected from an alternative dairy product, a syrup, a sauce, a coffee, and a tea; and
(b) an encapsulation surface comprising a gelled polysaccharide, which encapsulates the core composition.

2. The comestible capsule of claim 1, wherein the flavored base component is an alternative dairy product selected from a dairy milk and a dairy creamer.

3. The comestible capsule of claim 2, wherein the flavored base component is a dairy milk selected from coconut milk, oak milk, soy milk, almond milk, and chia milk.

4. The comestible capsule of claim 1, wherein the flavored base component is a coffee.

5. The comestible capsule of claim 1, wherein the flavored base component is a tea.

6. The comestible capsule of claim 1, wherein the core composition does not contain a fruit juice or a fruit puree.

7. The comestible capsule of claim 1, wherein the core composition is a liquid.

8. The comestible capsule of claim 1, wherein the core composition is a gel.

9. The comestible capsule of claim 1, wherein the comestible capsule comprises:
(a) a core composition comprising a sugar, a gum, a calcium ion source, and at least one flavored base component selected from an alternative daily product, a syrup, a sauce, a coffee, and a tea, wherein the core composition is a liquid; and
(b) an encapsulation surface comprising a gelled alginate, which encapsulates the core composition,
wherein the comestible capsule does not contain a starch, a fruit juice, or a fruit puree.

10. The comestible capsule of claim 1, wherein the comestible capsule comprises:
(a) a core composition comprising a sugar, a gelled alginate, and at least one flavored base component selected from an alternative dairy product, a syrup, a sauce, a coffee, and a tea, wherein the core composition is a gel; and
(b) an encapsulation surface comprising a gelled alginate and a calcium ion source, which encapsulates the core composition,
wherein the comestible capsule does not contain a starch, a fruit juice, or a fruit puree.

11. The comestible capsule of claim 1, wherein the core composition further comprises a colorant.

12. The comestible capsule of claim 11, wherein the core composition comprises more than one colorant, wherein each colorant is a different color.

13. The comestible capsule of claim 1, wherein the core composition further comprises a plurality of fruit pieces.

14. The comestible capsule of claim 1, wherein the comestible capsule has a round shape, an elliptical shape, or a tear-drop shape.

15. A composition comprising a plurality of the capsules of claim 1, wherein the composition is a food product.

16. The composition of claim 15, wherein the food product is a beverage selected from a coffee, a tea, a fruit juice, a smoothie, and a water.

17. A method of making the comestible capsule of claim 1, the method comprising:
(a) providing the core composition; and
(b) dispensing the core composition dropwise into a bath comprising an encapsulating agent, thereby forming an encapsulation surface,
provided that:
if the core composition comprises a polysaccharide, then the encapsulating agent is a calcium ion source, and
if the core composition comprises a calcium ion source, then the encapsulating agent is a polysaccharide.

18. The method of claim 17, comprising:
(a) mixing granulated a sugar, a gum, and the calcium ion source, thereby forming a dry blend;
(b) mixing the dry blend and the at least one flavored base component, thereby forming the core composition;
(c) dispensing the core composition dropwise into a bath having a surface and a depth of at least about 5.0 inches, wherein the core composition is dispensed from a height of at least about 8.0 inches above the surface, and wherein the encapsulating agent is the polysaccharide, thereby forming the encapsulation surface; and
(d) straining the capsule,
wherein the core composition is a liquid after the dispensing step, and
wherein the core composition remains in the bath for a time period of less than about 30 minutes.

19. The method of claim 17, comprising:
(a) mixing a sugar and the polysaccharide, thereby forming a dry blend;
(b) mixing the dry blend and at least one flavored base component, thereby forming the core composition;
(c) dispensing the core composition dropwise into the bath, wherein the encapsulating agent is a calcium ion source, thereby forming the encapsulation surface; and
(d) straining the capsule,
wherein the core composition is a gel after the dispensing step, and
wherein the core composition remains in the bath for a time period of from about 40 minutes to about 2 hours.

20. A comestible capsule prepared by the method of claim 17.
